(19) United States
(12) Patent Application Publication
(10) Pub. No.: US 2023/0010968 A1
(43) Pub. Date: Jan. 12, 2023

(54) Dried Cheese Pet Chew Treat

(71) Applicant: Marcoot Jersey Creamery LLC, Greenville, IL (US)

(72) Inventor: Audrea Wall, Sorento, IL (US)

(73) Assignee: Marcoot Jersey Creamery LLC, Greenville, IL (US)

(21) Appl. No.: 17/861,650

(22) Filed: Jul. 11, 2022

Related U.S. Application Data
(60) Provisional application No. 63/220,038, filed on Jul. 9, 2021.

(51) Int. Cl. A23K 10/20; A23K 50/42; A23K 40/20

(52) U.S. Cl. CPC A23K 10/20; A23K 50/42; A23K 40/20

(57) ABSTRACT

A dried chewy cheese product and pet chew treat is described. The cheese chew treat can be shelf-stable, dehydrated, and non-melting. In some embodiments, the cheese chew treat may be formed into a disk shape and may have a central hole. A process for making the dried cheese piece is also described. Methods of making the product may include the steps of pressing and forming the cheese, slicing it to a selected thickness, brining the unfinished cheese pieces, air drying the pieces on a drying rack, dehydrating the product to its final moisture content by placing the unfinished products into a drying chamber at a controlled temperature for a set duration, cooling the product, and removing surface oils.

### CROSS REFERENCE TO RELATED APPLICATIONS

This application claims the benefit of U.S. Provisional Patent Application 63/220,038, filed on Jul. 9, 2021, which is incorporated by reference herein in its entirety.

### FIELD OF THE INVENTION

The invention relates generally to an animal chew product and specifically to a pet chew comprising dried cheese. Embodiments of the invention provide a dehydrated, dairy-based, edible animal chew, that is nutritious, shelf-stable, and presents a low choking risk.

### BACKGROUND

Animals, especially dogs, enjoy chewing firm objects and there are numerous edible chew products. Many pet owners would like to provide their pets with edible chew products that are natural, nutritious, shelf-stable, free of preservatives, high in protein, and having a composition and texture that promotes lengthy chewing without producing fragments that may lead to choking or intestinal blockage.

Dairy products can be naturally nutritious and high in protein. However, conventional dog chew products using dairy do not provide the desired combination of features. For example, a dried extruded yak-milk cheese is marketed as an edible dog chew product, but the hard, stick-shaped product leaves an end portion which may be a choking hazard. In another example, cheese may be freeze-dried to provide an edible pet treat, but such products may have a composition that is brittle and chalky, and does not provide a chewy texture. As another example, some chew products using dairy are highly-processed cheese-flavored products that use cheese powder or fragments with binders, artificial preservatives, and high-carbohydrate fillers.

Thus, there is a need for a nutritious, flavorful, digestible animal chew product, composed of natural ingredients, having a shape and texture that safely provides pet chewing satisfaction.

### SUMMARY

An edible dried cheese chew treat product is described. Systems, devices, and methods for making the cheese chew treat product are also described.

### BRIEF DESCRIPTION OF THE DRAWINGS

FIG. 1A shows a perspective view of an embodiment of a cheese chew treat.

FIG. 1B shows a top plan view of an embodiment of a cheese chew treat.

FIG. 1C shows a side elevation view of an embodiment of a cheese chew treat.

FIG. 1D shows a perspective view of an embodiment of a cheese chew treat.

FIG. 2A shows a flow chart of an example method for making a cheese chew treat.

FIG. 2B shows a graphical depiction of an example method for making the product.

FIG. 3 shows an example pressing system for making the product.

FIG. 4 shows an example slicing system for making the product.

FIG. 5 shows an example brining process for making the product.

FIG. 6 shows sliced cheese rounds on a drying tray at the beginning of a drying process.

FIG. 7 shows an example dehydration system for making the product.

FIG. 8 shows an example of a system for removing surface oil.

### DETAILED DESCRIPTION

The cheese chew treat product comprises cheese or consists essentially of cheese. Cheese ingredients include mild solids, cheese culture, rennet and salt. While the product may have some salt, it has no added preservatives or binders. The cheese chew treat product is firm and chewy. The product is stiff and not substantially bendable. The product is shelf-stable for a period of at least 6 months. The cheese chew treat is substantially non-melting.

Without wishing to be bound by theory, it is believed that the combination of the texture, consistency, and dimensional properties confer benefits in reducing choking hazards and allowing for complete consumption by a dog or a similar animal. In particular, the fat content and water content are controlled, and the selected thickness, combined with a central hole, confers a propensity for the cheese chew treat to crumble after a dog chews for a suitable period of time, breaking it into smaller bits which can be easily swallowed, thereby reducing choking hazards. The cheese chew treat product may be further customized for different size dogs by modifying the size and shape of the product.

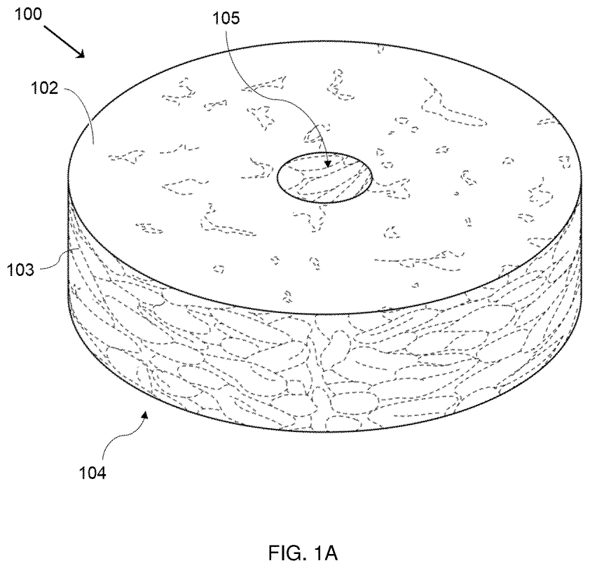

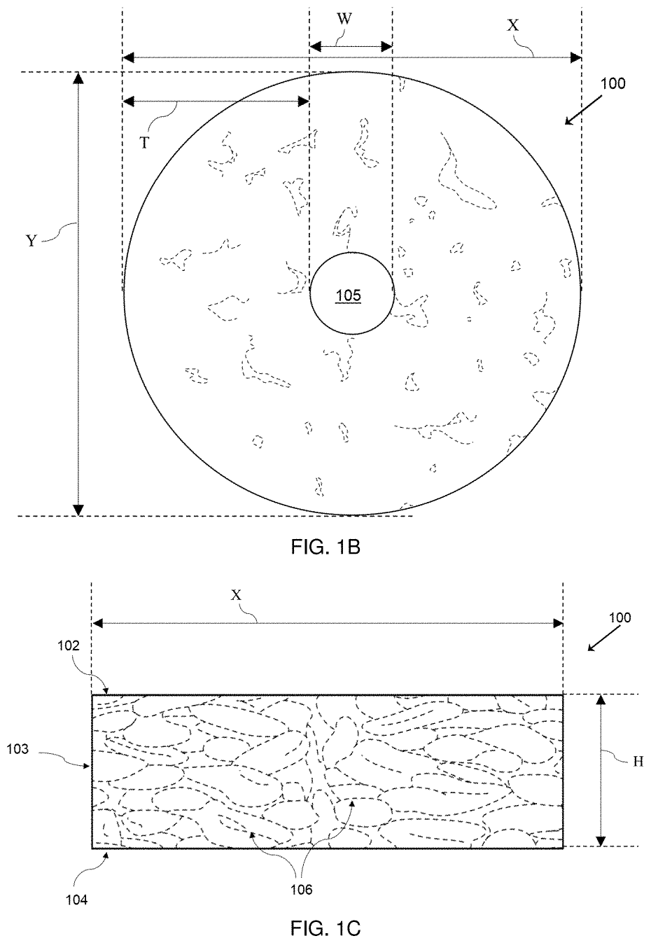

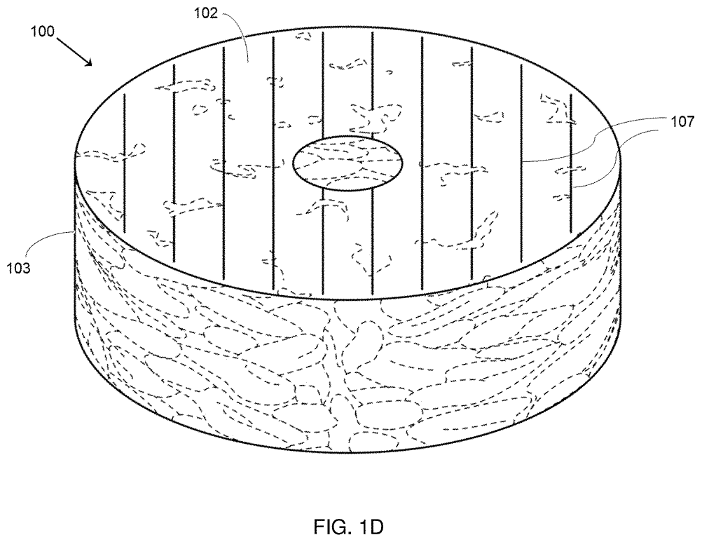

Turning now to FIGS. 1A-1C, one example of the cheese chew treat product 100 is shown. FIG. 1D shows another example of the cheese chew treat 100 including an embossed pattern 107 of parallel lines. In the examples shown in FIGS. 1A-1D, the cheese chew treat 100 has a flattened cylindrical or disk-like shape with a central hole or aperture.

With continuing reference to FIGS. 1A-1D, the cheese chew treat 100 has a top surface 102, at least one side surface 103, and a bottom surface 104. The cheese chew treat 100 may also have a hole or aperture 105. Formed from pressed curds, the cheese chew treat 100 may show vestigial curd edges or grain boundaries 106 The cheese chew treat 100 has dimensional attributes, including a width X, a length Y, a height H, and a radial thickness T. In embodiments having a cylindrical outer profile, both the length Y and width X are equal to the cylinder diameter. In embodiments with a hole or aperture 105, the aperture may have an aperture width W. In some embodiments, the aperture may be circular and centrally located in the cheese chew treat 100.

In some embodiments, the ratio of width X to length Y is in a range from 1.0:1.5 to 1.5:1.0; in a range of 1.0:1.2 to 1.2 to 1.0; or about 1:1. In some embodiments, the ratio of width X to height H is greater than 3:1, greater than 4:1, greater than 5:1, greater than 6:1, or, greater than 7:1. In some embodiments, the ratio of width X to height H is less than 20:1, less than 15:1, less than 12:1, less than 11:1, less than 10:1, less than 9:1, less than 8:1, less than 7:1, less than 6:1, or less than 5:1. In some embodiments, the ratio of width X to height H is in a range from 4:1 to 10:1. In some embodiments, a ratio of product width X to aperture width W is greater than 3:1, greater than 4:1, greater than 5:1, greater than 6:1, greater than 7:1, greater than 8:1, or greater than 9:1. In some embodiments, a ratio of product width X to aperture width W is less than 15:1, less than 12:1, less than 11:1, less than 10:1, less than 9:1, less than 8:1, less than 7:1, less than 6:1, or less than 5:1.

In a first example embodiment, the cheese chew treat is adapted for medium to large dogs, and has a total diameter of approximately 6-8 cm with a central aperture width of approximately 1.0-1.5 cm, and a thickness of about 1.2-1.7 cm. The first example embodiment weighs approximately 40-50 g. In a second example embodiment, the cheese chew treat is adapted for smaller dogs, has a total diameter of approximately 4.5-5.5 cm, a central hole diameter of about 0.8-1.2 cm, and a thickness of about 1.1-1.5 cm. The second example embodiment weighs approximately 24-26 g. Both the first and second example embodiments have a density in a range of 0.8 to 1.3 g/cm², or about 0.9 to 1.1 g/cm².

In some embodiments, the cheese chew treat products have a water moisture content of less than 10%, in a range of 1% to 9%, in a range of 2% to 8%, in a range of 1.5% to 4.5%, or about 3% to 6%. The products have a protein content greater than 30%, in a range of 30% to 90%, or in a range of 30% to 65%.

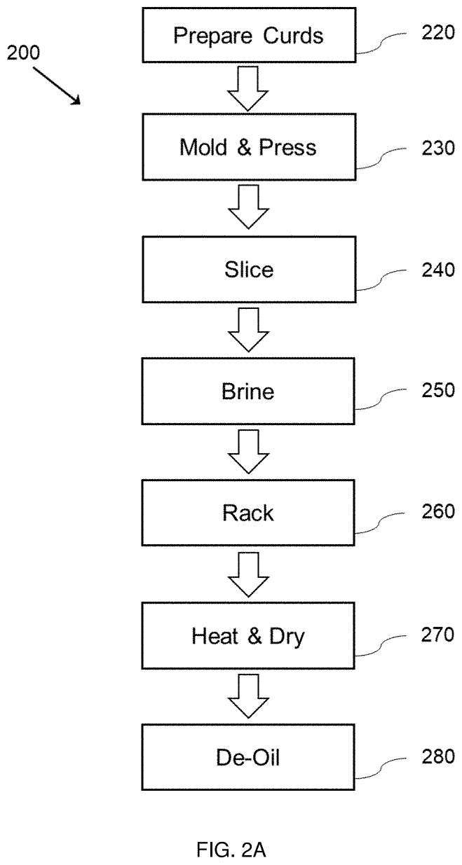

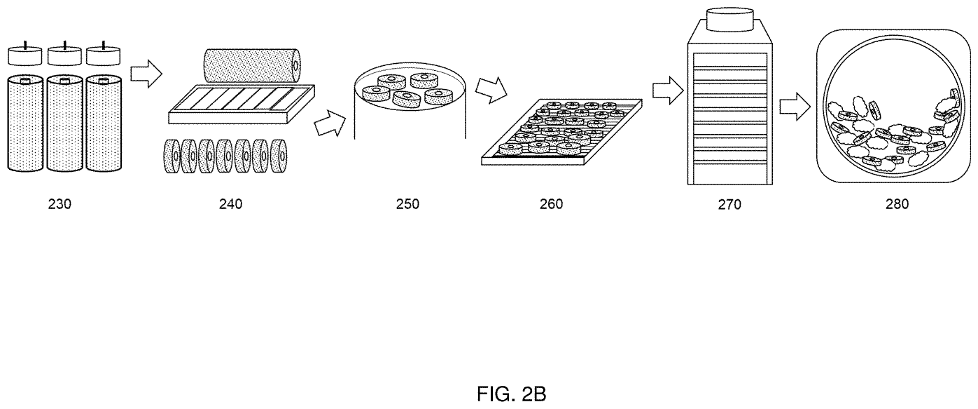

Turning now to FIGS. 2-8, an example method for producing the product is illustrated.

With reference to FIGS. 2A-2B, a flow chart and a simplified illustration of example process steps for the method of making the product is shown. The method 200 may include a plurality of steps. Curds are prepared 220 and the curds are placed into forms and pressed 230. The pressed and formed block is removed from the forms and sliced 240 into pieces or segments. The sliced pieces are brined 250. The brined pieces are drained 260 and may be put onto a drying rack. The pieces are then dehydrated 270, to dry the product to its final moisture content. The dehydration step 270 may include placing racks of the pieces into a dehydration chamber with controlled temperature and airflow. After dehydration, the pieces may optionally be de-oiled 280, to remove some surface oils.

In an example, the product may be prepared in the style of a hard style, or an alpine style, cheese. To prepare the curds, fluid milk is curdled with vegetable rennet and culture, producing curds and whey. The whole curds may be produced, for example, by adding rennet and cheese culture to pasteurized cow's milk having a fat content of 2% to 3%. Use of fat-free or lower fat milk can produce a product that has a more rubbery and less crumbly texture. The curds are strained from the whey and put it into the forms.

In some embodiments, preparing the curds may further comprise incorporating an additive, such as a flavoring, a coloring, or a nutritional supplement. To produce a more uniform product, a liquid or solid additive may be incorporated before the curds and whey are separated. To produce a more variegated product, a liquid or solid additive may be incorporated after the first separation of curds and whey.

Curd size can influence product texture, density, and propensity to crumble. In some embodiments, the prepared curds are whole curds, wherein 50% of the weight of prepared curds comprises curds having a size in a range of 1.0 mm to 30.0 mm, wherein size is measured along the longest linear axis of each curd. In some embodiments, average curd size is approximately 1.0 cm±0.5 cm. In some embodiments, 50% of the weight of prepared curds comprises curds having a size equal to or greater than 1.0 mm, 1.5 mm, 2.0 mm, 3.0 mm, 4.0 mm, 5.0 mm, 6.0 mm, 7.0 mm, 8.0 mm, 9.0 mm, 10.0 mm, 11.0 mm, 12.0 mm, 13.0 mm, 14.0 mm, 15.0 mm, or 1.6 mm. In some embodiments, 50% of the weight of prepared curds comprises curds having a size less than or equal to 35.0 mm, 30.0 mm, 25.0 mm, 20.0 mm, 18.0 mm, 16.0 mm, 15.0 mm, 14.0 mm, 13.0 mm, 12.0 mm, 11.0 mm, 10.0 mm, or 9.0 mm.

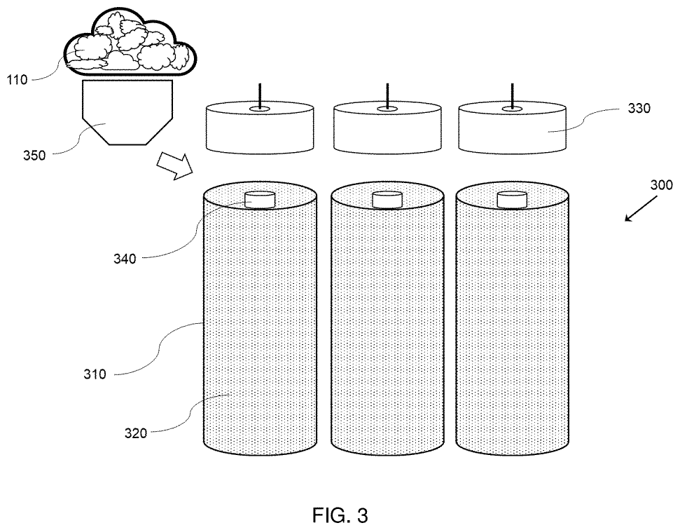

A pressing system 300 is shown in FIG. 3. Prepared curds 110 are pressed into molds or forms 310. The forms 310 may be cylindrical and elongated, with a height more than twice its diameter. In some embodiments, a ratio between form height and diameter is greater than 2:1, greater than 3:1, greater than 4:1, or greater than 5:1. In some embodiments, a ratio between form height and diameter is less than 10:1, less than 9:1, less than 8:1, less than 7:1, less than 6:1, less than 5:1, or less than 4:1.

The forms or molds may have holes or perforations 320 for draining whey during the pressing step. The forms may optionally have one or more rods or pillars 340 to define a toroid void for shaping the curds during the pressing step. A pillar 340 may be located at or near the center of the molding form 310, as depicted in FIG. 3. Prepared curds 110 may be loaded from a loading hopper 350 into the forms 310. The forms may be manually hand-packed or loaded by an automated process. Once loaded, a press head 330 compresses the curds in the forms 310. The pressing system 300 may comprise a plurality of press heads 330 which may be connected to a press plate and/or a lever arm. Multiple forms 310 may be pressed simultaneously. In some examples, the pressing may be performed by a pneumatic press.

During the process of pressing the curds, some liquid whey is squeezed out and curd solids become closely packed. Whey drains from the holes in the forms. The pressing system 300 may optionally include a catchment for whey discharge or recovery.

In a first example pressing process, stiff-sided cylindrical forms include one central pillar and the forms have an inside diameter of approximately 3 inches, or about 7.6 cm, for making a finished product with a width X of about 6.5 cm. In a second example pressing process, cylindrical forms include one central pillar and the forms have an inside diameter of about 2.25 inches, or about 5.7 cm, for making a finished product with a width X of about 6.5 cm. In some embodiments, the forms may have a diameter in a range of 5.0 cm to 15.0 cm. During the process of pressing the curds, some liquid whey is squeezed out and the curd solids become closely packed. Whey drains from the holes in the forms.

The forms may optionally have a non-cylindrical shape, with a plurality of side wall segments to produce different cross-sectional shapes for the finished product. In some examples, the cross-sectional shape of the form and resulting product is a pentagon, hexagon, heptagon, or octagon. In some alternatives, perforated sidewalls of the forms may encompass a mesh and scaffold structure, whereby the flexible mesh retains the curds while allowing whey to drain, and the scaffold provides shape and structure during the pressing. Flexible mesh sides may be used in forming a plurality of rounded sides, such as a quatrefoil or a rounded flower-like cross-sectional shape.

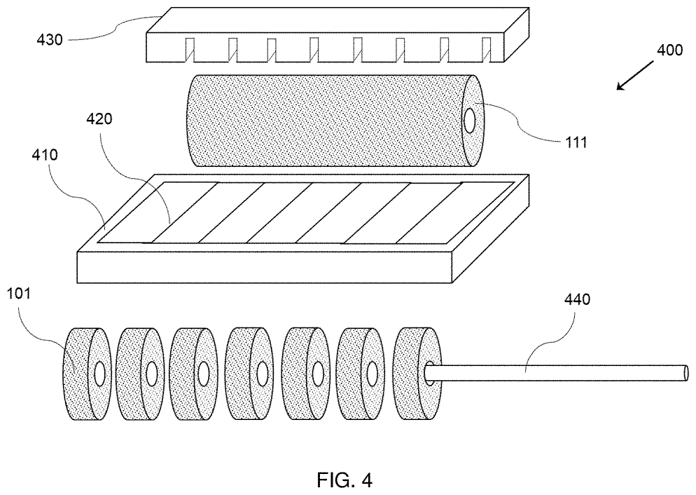

Once the cheese is pressed it is removed from the forms and cut into thick slices. Turning now to FIG. 4, a simplified slicing system is illustrated. A pressed block 111 is positioned between a cutting frame 410, including at least one blade or cutter 420, and a slicing guide 430. The block 111 is compressed between the slicing guide 430 and cutting frame 410 such that the cutters 420 are pressed into the block 111 to form sliced segments or pieces 101. In embodiments in which the sliced, unfinished pieces 101 have an aperture 105, a rod 440 may be inserted into the aperture of the pieces 101 to facilitate collection and transport of the pieces.

In some embodiments, the cutting frame 410 comprises a plurality of cutters 420. In an example slicing system 400, the frame 410 may comprise between 5 to 20 cutters 420, In another example, the frame may comprise 5 to 35 cutters. The cutters may comprise a set of parallel wires or parallel blades. To form pieces with substantially smooth surfaces on the top and bottom, the cutters may comprise wires or blades that are flat and straight. Alternately, a wavy or zig zag surface may be formed by using shaped blades.

The system may be manual or automated. In an example system, the cutters are wire, the cutting frame is located under the slicing guide, and the pressed block is pressed downward against the wires and sliced into pieces as it moves past the wires. In another example system, the cutters are wire; the slicing guide is located under the cutting frame; the slicing guide comprises a plurality of curved or angled slats; the plurality of slats are configured to cradle the pressed block, while also permitting the cutters to pass between the slats; and the cutting frame and cutters are pressed downward against the block to slice the block into pieces as wires or blades moves past the block and between the slats.

In an example cutting process, the pressed cheese block has an elongated cylindrical shape with a central aperture and is sliced to thicknesses of approximately ⅝ inches, or about 1.6 cm, forming pieces with a round shape with a hole in the middle. In some embodiments, the slice thickness may be in a range of 1.0 cm to 3.0 cm, in a range of 1.25 cm to 2.55 cm, or in a range of 1.3 cm to 2.3 cm.

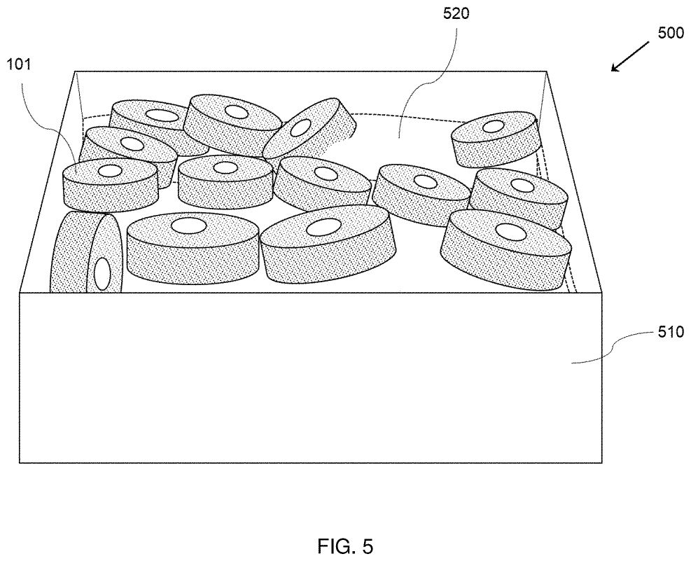

Turning now to FIG. 5, a brining system 500 is shown. The unfinished cheese pieces 101 are contacted with a brine solution 520 and may be soaked with the brine 520 in a brining vessel 510.

In an example process, the sliced pieces are placed into a brine solution for a brining period. In some example processes, the brine may be made with non-iodized fine salt (NaCl) dissolved in water and may include calcium chloride (CaCl₂). The brine may have a pH in a range of 4.0 to 8.0, in a range of 4.5 to 7.0, in a range of 5.0 to 5.5, or may have a pH of approximately 5.2. A plurality of the in-process cheese pieces 101 may be soaked the brine until the pieces reach a desired hardness and saltiness. In an example process, the brining period may be about 45 to 60 minutes, in a range of 20 to 120 minutes, or in a range of 10 to 240 minutes. After the brining period, the pieces are removed from the brine solution. Reducing the brining period to the lower end of the range can produce a product with a lower salt content.

After brining. the pieces may optionally be air-dried. In an example process, the pieces are air-dried for a period of 10 minutes to 360 minutes.

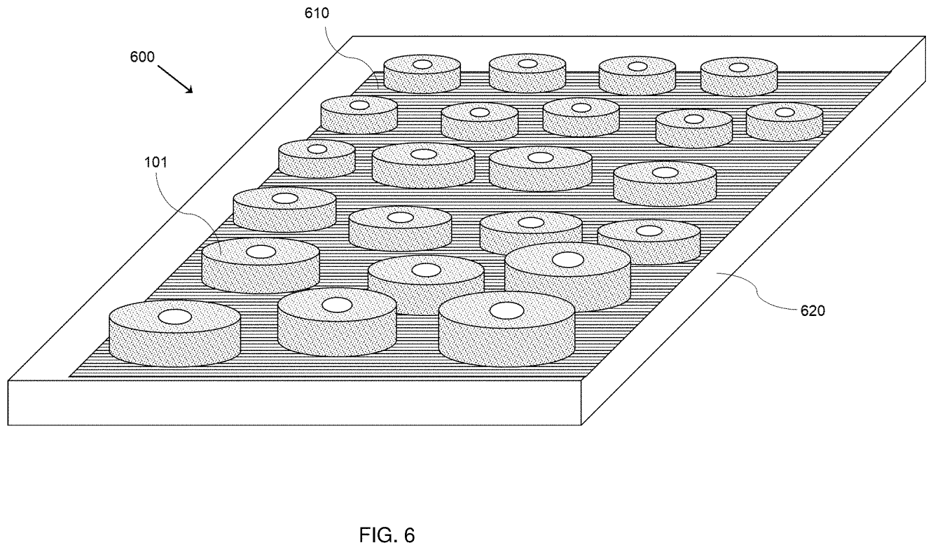

Turning to FIG. 6, the pieces may be drained and dried using a drying apparatus 600. The drying apparatus 600 may comprise a drying rack or mat 610, which may be supported by a drying tray 620. The unfinished brined pieces 101 are placed onto the drying apparatus 600.

In some embodiments, the drying mat is an integrated part of the tray, for example a stiff mat or rack that also provides the support of a tray. In other embodiments, the mat and rack are separate components adapted for use together, for example a flexible mesh draining mat may be supported by the tray. In an alternate embodiment, pieces with holes may be supported by a rack comprising a plurality of rods configured to support the pieces by passing through the aperture of each piece.

In an example process, brined cheese pieces are placed onto a pan or drip tray to dry or drain. A substantially flat surface of each cheese piece may directly contact the pan or tray, or a mesh pad or draining mat may optionally be placed between the flat surface of the cheese pieces and a pan or tray. In some embodiments, the pan or tray may have a textured or perforated base to facilitate drainage and airflow. In some embodiments the draining mat or textured tray may have raised portions to emboss a design into the substantially flat surface of each cheese piece. In the embodiment shown in FIG. 1D, one of the flat surfaces is lightly embossed with parallel lines.

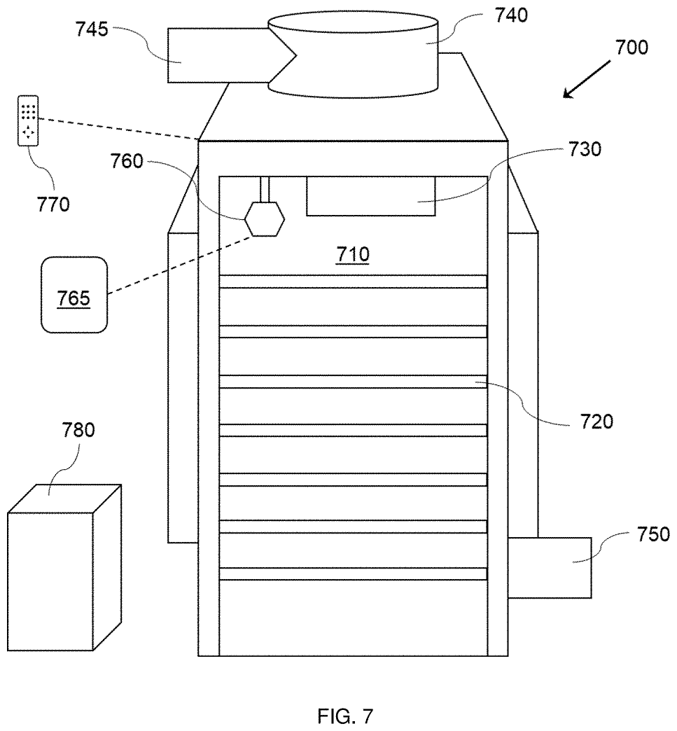

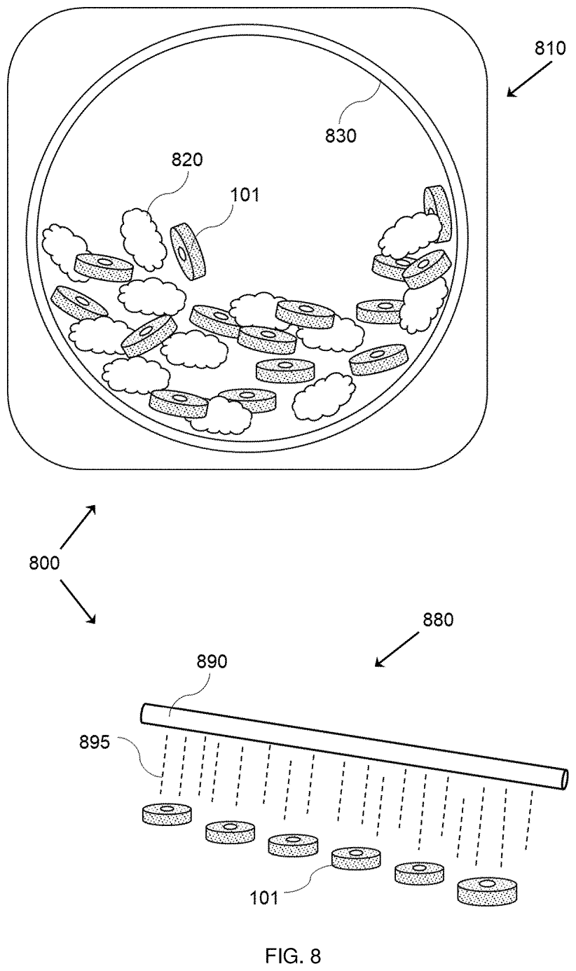

Turning to FIG. 7, an example dehydrator system 700 is shown. The dehydrator system promotes dehydration of the in-process cheese pieces by circulating heated air. In addition to temperature, the dehydrator system may also regulate humidity and airflow. The dehydrator system 700, may comprise a chamber 710 with rack supports 720. The system includes a heater 730 and a fan or blower 740. The blower may be connected to an air intake 745. The system can include an air outlet 750. The system can include one or more sensors 760 for measuring conditions in the chamber 710, including for example, temperature or humidity. The system may include a controller 770 and a display 765 which may be linked to the one or more sensors 760. The system may include a dehumidifier 780. The dehumidifier 780 may be physically integrated and connected to the chamber 710, or may be placed near the air inlet 745 close to, but separated from, the chamber 710.

At the start of the dehydration process, the cheese is fresh, no more than about a day old, or less than 36 hours from the step of forming the curds. If heated dehydration is performed on older cheese pieces, the pieces are prone to melting.

In an example dehydration process, a set of drying trays 620, holding a plurality of brined segments or pieces 101, are placed onto the rack supports 720 in the dehydration chamber 710. A plurality of trays may be supported by a rack and one or more racks supporting the pans or trays holding the cheese pieces are placed into the dehydrator. In an example process, the cheese is processed in the dehydration chamber for approximately 50-72 hours. The time may be adjusted for is humidity levels and moisture levels. The process may be performed at ambient pressure or at about 1 atmosphere of pressure. The dehydrator system monitors and controls temperature and may also be used to control humidity and airflow within the drying chamber.

In an example system, the dehydrator may have a heating element and blower positioned above or near the top of the chamber. The dehydrator system monitors and controls temperature, humidity, and airflow within the drying chamber. The dehydrator may use convection-style electric heating with a blower and dehumidifier. Air intake may draw in air having about 40-60% humidity at about 70-80 degrees Fahrenheit or in a range of about 20-27 Celsius. The dehydrator system heats the air and circulates it into the chamber. The system may have a blower configured to operate at 400-1000 cfm, 600-900 cfm, or between 700-800 cfm. It blows the air down over the cheese on the racks. The system may include a vent near the bottom of the chamber and may recirculate the air.

The racks are spaced to permit good airflow, and the distance from the base of one drying tray to the base of a vertically adjacent drying tray may be greater than 6 cm, greater than 8 cm, greater than 10 cm, or in a range of 6-20 cm. The airflow configuration facilitates the air and heat to move with substantial evenness through the drying chamber and over every piece of cheese. The drying rack or mat may further facilitate airflow under the pieces. The temperature may be modulated during the dehydration and drying process.

In an example dehydration process, the drying chamber is maintained at approximately 130° F. to 140° F. for a first period of about 24 hours, or within a range of 18 to 36 hours. The temperature of the drying chamber is then increased to approximately 140° F. to 150° F., or about 145° F. to 150° F., for a second period of about 24 hours, or within a range of 18 to 36 hours. Optionally, the drying may be continued for a third contiguous period of 1 to 24 hours at a temperature in a range of approximately 110° F. to 150° F., or about 120° F. to 150° F.

After the cheese is dehydrated, it is removed from the dehydrator and may be passively cooled to below 95° F. or 35° C., or to ambient room temperature. When removed from the dehydrator, the cheese pieces may have oil or liquid fats on the surface of the pieces. The pieces may be de-oiled to remove at least a portion of the oils from the surface before packaging. This may be performed by manually patting down the pieces with an absorbent material, by using an air knife, or by using a tumbler.

Referring now to FIG. 8, a de-oiling system 800 may include a tumbler system 810, or an air knife apparatus 880, or both. In a tumbler system 810, a batch of pieces 101 may be placed into a drum 830 with absorbent pads 820. An air knife apparatus 880 may be used to direct air through a manifold 890 and produce directed air flow 895 over the pieces. Optionally, an air knife system may include an absorbent material below the pieces, or may include a conveyance system, such as a conveyor belt that transports the pieces under the manifold.

In an example de-oiling system, a plurality of cheese pieces may be placed into a rotating drum, the rotating drum may be lined with an absorbent material, and/or a plurality of absorbent pads may be placed into the drum. In an example, the absorbent pads may comprise reusable, washable, cotton-fabric pads. The drum may be rotated to contact the cheese pieces with the absorbent material or pads, thereby removing at least a portion of the excess surface oil. Subsequently, the finished cheese chew treat product may be packaged.

Through the dehydration process the cheese will lose approximately 30% of its weight and the dehydrated product has a smaller size. The finished cheese chew treat 100 has a shape that is smaller, but generally congruent to a shape of the unfinished cheese pieces 101. In some embodiments the finished product is about 15% smaller than unfinished pieces at the slicing stage of processing. The degree of size change can vary depending on moisture content, in some embodiments, the finished cheese chew treat 100 is between 5% to 30% smaller than unfinished pieces.

The finished cheese chew treat 100 may be dehydrated to be shelf stable. The water activity levels for a shelf stable product may be less than or equal to 0.85. The water activity (a w) of a food is the ratio between the vapor pressure of the food itself, when in balance with the surrounding air media, and the vapor pressure of distilled water under identical conditions. In some embodiments, the finished cheese chew treat is shelf-stable and suitable for consumption for at least 6 months after it is produced. In some embodiments, the finished cheese chew treat is shelf-stable and suitable for consumption for at least 6 months, at least 9 months, at least 12 months, at least 15 months, at least 18 months, or for 24 months after it is produced.

According to the embodiments provided herein, an edible cheese chew treat, pet chew or dried cheese piece is provided.

In some embodiments, the cheese chew treat can include a segment formed from milk curds, formed into a shape, and dehydrated.

In some embodiments, the cheese chew treat can be produced from whole curds from 2-3% milk. In some embodiments, the cheese chew treat is produced from milk from a cow, sheep, goat, or water buffalo. In some embodiments, the cheese chew treat is produced from cow's milk. In some embodiments, the cheese chew treat is produced from goat's milk.

In some embodiments, the edible cheese product uses alpine-style cheese curds.

In some embodiments, the dried cheese product has water content up to 4% v/v.

In some embodiments, the cheese chew treat has a water activity level of up to 0.85. In some embodiments, the cheese chew treat has a water activity level of less than 0.85, less than 0.80, or less than 0.75.

In some embodiments, the edible cheese product has a shape of a circle, toroid, disk, ring, or cylinder.

In some embodiments, the edible cheese product has a shape of a flattened cylinder with a hole through a central axis.

In some embodiments, the edible cheese product has a hole through its thickness, the hole having a maximum aperture width, or cross-sectional width perpendicular to the thickness, in a range of 5 mm to 20 mm. In some embodiments, the edible cheese product has a hole through its thickness, the hole having a maximum aperture width, in a range of 9 mm to 12 mm. In some embodiments, the edible cheese product has a hole having a aperture width in a range of 8 mm to 15 mm.

In some embodiments, the cheese chew treat has a thickness in a range of 10 mm to 20 mm. In some embodiments, the cheese chew treat has a height or thickness of about 15.9 mm. In some embodiments, the edible cheese product has a shape of a cylinder with a height in a range of 10 mm to 17 mm.

In some embodiments, the edible cheese product has a shape of a cylinder with a diameter in a range of 25 mm to 100 mm. In some embodiments, the edible cheese product has a shape of a cylinder with a diameter of about 25 mm to about 50 mm. In some embodiments, the edible cheese product has a shape of a cylinder with a diameter in a range of 50 mm to 75 mm.

In some embodiments, the cheese chew treat has a density in a range of 0.9 g/cm² to 1.1 g/cm². In some embodiments, the cheese chew treat has a density in a range of 0.85 g/cm² to 1.15 g/cm². In some embodiments, the cheese chew treat has a weight in a range of 15 g to 75 g, in a range of 20 g to 60 g, or in a range of 20 g to 50 g.

In some embodiments, the edible cheese product comprises cheese, consists essentially of cheese, or consists of only cheese.

According to the embodiments provided herein, a method of making an edible cheese product can include dehydrating cheese segments or pieces.

In some embodiments, the method includes preparing cheese curds by curdling a 2-3% milk with a rennet and a culture. In some embodiments, the rennet is a vegetable rennet. In some embodiments, the culture is a freeze dried culture derived from cow's milk.

In some embodiments, the method includes placing cheese curds into forms and pressing the cheese curds into a unit or block comprising cheese solids. In some embodiments, the forms have a circular cross-sectional area and a pillar in the center of the circular cross-sectional area. In some embodiments, the forms have a circular cross sectional area with a diameter or width of about 35 mm to about 95 mm, in a range of 40-80 mm, in a range of 45-80 mm, or in a range of 50-75 mm.

In some embodiments, the method includes removing the block from the forms and cutting it into pieces. In some embodiments, the segments are cut to a thickness in a range of 10.0 mm to 20.0 mm, or in a range of 12.0 mm to 18.0 mm, or about 15.9 mm. In some embodiments, the pieces have a substantially uniform thickness and cross-sectional area.

In some embodiments, the method includes placing cheese pieces into a salt brine. In some embodiments, the pieces are placed into the salt brine for a brining period in a range of 5 minutes to 120 minutes. In some embodiments, the pieces are placed into the salt brine for a brining period in a range of 15 minutes to 60 minutes. In some embodiments, the pieces are placed into the salt brine for about 15 minutes. In some embodiments, the pieces are placed into the salt brine for a brining period in a range of 45 minutes to 60 minutes. In some embodiments, the brine has a buoyancy of about 20.

In some embodiments, the method includes placing brined pieces onto a tray, mat, or rack. In some embodiments, the method includes placing brined pieces onto a tray and/or drying mat having a raised surface pattern.

In some embodiments, the method includes embossing a pattern onto the cheese chew treat by placing brined segments onto a tray and/or drying mat having a raised surface design complementary to the pattern, thereby embossing the pattern onto the cheese chew treat.

In some embodiments, the method includes placing the tray onto a rack and placing the rack into a drying chamber of a dehydrator system and dehydrating the pieces.

In some embodiments, the method includes the segments are dehydrated at about 130° F. for approximately 24 hrs and then at about 148 F to about 150 F for an additional 24 to 48 hrs.

In some embodiments, the method includes adding a non-dairy additive. In embodiments having a non-dairy additive, the additive is less than 5% by weight, measured as additive weight relative to product weight. In embodiments having a non-dairy additive, the additive may comprise less than 5%, less than 4%, less than 3%, less than 2%, less than 1%, or less than 0.5% by weight. In some embodiments, the additive is a natural non-dairy additive, and the natural non-dairy additive comprises a colorant, a nutrient supplement, a flavoring, or a plant product.

In some embodiments, the additive is a liquid.

In some embodiments, the additive is a solid. In some embodiments, the additive is a solid with a small particle size, wherein size is measured along the longest linear axis of each bit or particle. In some embodiments, the additive is a solid wherein at least 50% of the additive by weight is smaller than 3.0 mm. In some embodiments, the additive is a solid wherein at least 50% of the additive by weight comprises particles having a size less than or equal to 5.0 mm, 3.0 mm, 2.5 mm, 2.0 mm, 1.8 mm, 1.6 mm, 1.5 mm, 1.2 mm, 1.1 mm, 1.0 mm, or 0.9 mm.

In some embodiments, the additive includes at least one of: carrot extract, beet extract, cabbage extract, elderberry juice, grape skin extract, cranberry extract, caramel, annatto, beta-carotene, anthocyanin, lycopene, paprika, or turmeric.

In some embodiments, the additive includes at least one of: a vitamin, a mineral, a fatty acid, a peptide, a polysaccharide, or an enzyme. In some embodiments, the additive includes at least one of: glucosamine, methylsulfonylmethane (MSM), chondroitin, α-linolenic acid (ALA), eicosapentaenoic acid (EPA), or docosahexaenoic acid (DHA).

In some embodiments, the additive includes a meat product. In some embodiments, the natural non-dairy additive includes bacon crumbles. In some embodiments, the natural non-dairy additive includes freeze-dried meat. In some embodiments, the additive includes freeze-dried liver. In some embodiments, the additive includes dried fish. In some embodiments, the additive includes fish oil.

In some embodiments, the natural non-dairy additive includes a freeze-dried vegetable, fruit, or seaweed. In some embodiments, the additive includes dried cranberry pieces. In some embodiments, the additive includes a seed or nut, such as a peanut or tree nut. In some embodiments, the additive includes flaxseed, bran, or wheat germ.

In some embodiments, the method includes adding an additive to the milk before curdling. In some embodiments, the method includes incorporating an additive before the curds and whey are separated. In some embodiments, the method includes incorporating an additive after an initial separation of curds and whey. In some embodiments, the method includes incorporating an additive with the curds before the prepared curds are put into the forms and pressed. In some embodiments, the method includes adding an additive to the brining solution.

It is noted that the terms “substantially” and “about” may be utilized herein to represent the inherent degree of uncertainty that may be attributed to any quantitative comparison, value, measurement, or other representation. These terms are also used to represent the degree by which a quantitative representation may vary from a stated reference without resulting in a change in the basic function of the subject matter at issue.

The appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A cheese chew treat, comprising:
a segment formed from curds pressed into a shape and dehydrated, wherein the cheese chew treat has a weight in a range of 15 g to 150 g.

2. The cheese chew treat of claim 1, wherein the curds are whole curds from cow's milk with 2-3% fat content.

3. The cheese chew treat of claim 1, wherein the curds are alpine style cheese curds.

4. The cheese chew treat of claim 1, wherein the shape is a flattened cylinder with an aperture therethrough.

5. The cheese chew treat of claim 1, wherein the cheese chew treat has a water content less than or equal to 4% v/v.

6. The cheese chew treat of claim 1, wherein the cheese chew treat has a water activity level of less than 0.85.

7. The cheese chew treat of claim 1, wherein the cheese chew treat has a height in a range of 12 mm to 28 mm.

8. The cheese chew treat of claim 1, wherein the cheese chew treat has a width in a range of 45 mm to 150 mm.

9. A method of making a cheese chew treat comprising:
preparing cheese curds by curdling a 2-3% milk with a rennet and a culture;
placing the cheese curds into forms and pressing the cheese curds into a block;
cutting the block into pieces;
brining the pieces;
placing the pieces into a dehydration chamber; and
dehydrating the pieces.

10. The method of claim 9, further comprising incorporating an additive, wherein the additive comprises a colorant, a nutrient supplement, a flavoring, or a plant product.

11. The method of claim 9, further comprising incorporating an additive, wherein the additive comprises meat.

12. The method of claim 9, wherein the pieces are dehydrated for a first period at about 130-140 F for 20-30 hours, then dehydrated for a second period at about 145-150 F for 20 to 50 hours, wherein the second period is consecutive and contiguous to the first period.
